(19) United States
(12) Patent Application Publication
(10) Pub. No.: US 2015/0154643 A1
(43) Pub. Date: Jun. 4, 2015

(54) INTERACTIVE INFORMATION, WAYFINDING AND MESSAGE TARGETING DEVICES, SYSTEMS AND METHODS

(71) Applicant: Chris Wiegand, Cambridge (CA)

(72) Inventors: Adam Artman, Toronto (CA); Chris Wiegand, Cambridge (CA)

(21) Appl. No.: 13/978,577

(22) PCT Filed: Jan. 9, 2012
(86) PCT No.: PCT/CA12/00006

§ 371 Date: Oct. 9, 2013

Related U.S. Application Data
(60) Provisional application No. 61/430,994, filed on Jan. 8, 2011.

(51) Int. Cl. G06Q 30/02

(52) U.S. Cl. CPC G06Q 30/0269

(57) ABSTRACT

A computer network implemented system is provided for generating and displaying interactive map information, wherein the system includes: computing devices that are linked to a central server and configured to display wayfinding content and associated content. The central server includes an integrated wayfinding content management utility that enables updating of: (1) a wayfinding map for a particular location, (ii) one or more customer business objectives: and (iii) one or more rules for (A) establishing dynamically a user profile based on one or more wayfinding requests from a user, (B) generating one or more targeted messages for promoting the business objectives, and for (C) determining one or more display parameters for displaying the wayfinding content, and the targeted messages in connection with the wayfinding content, in a way that promotes the business objectives.

### FIELD OF INVENTION

This invention relates generally to computer implemented wayfinding systems and methods. This invention also related to targeted digital marketing system and solutions.

### BACKGROUND OF INVENTION

In the prior art, prior art digital wayfinding systems exist for use in high-traffic areas. “Wayfinding” refers generally to technologies or techniques that enable people to orient themselves in physical space and navigate from place to place. Usually wayfinding solutions are required in relation to a relatively complex physical environment, whether this is an outdoor space such as a defined urban environment or an indoor space such as a hospital, mall, or transit system. Wayfinding solutions are useful in any situation where an information booth or physical map may be required to orient oneself, or to navigate in the physical environment.

Typical implementations of wayfinding solutions include interactive displays or kiosks that enable a user to access information on how to navigate from point A (usually the location of the display or kiosk) to point B, or points B to N. For example prior art wayfinding kiosks are known that generally include a computer, a memory, a computer program including wayfinding functionality, and in some cases means for incorporating messaging and/or advertising into information displayed in response to wayfinding requests from a user.

Users of a wayfinding system represent a captive audience that is of interest to various stakeholders including for examples the operators or managers of the physical space (for example store or mall owners, municipalities, hospital administrators, transit providers and so on). There is demand for delivering richer contextual information, and there is also a demand for delivering targeted communications such as advertisements or promotions. Users of wayfinding systems, however, tend to be focused on their goal of getting from Point A to Point B and therefore there is a need to ensure that such information or targeted messaging (generally referred to as “targeted messaging” in this disclosure is as relevant as possible to the user and to their current objectives (e.g. get to Gate X in an airport, find store Y to purchase A) and therefore it is important to curtail the targeted messaging to a manageable amount of information, displayed in an accessible way. The challenge is that determining user objectives and the type of targeted messaging that is most likely to be well received in the circumstances can be complicated, and may depend on a wide variety of factors.

There is a need therefore for wayfinding solutions that incorporate performance advertising type techniques. However, targeting messages to a user of a wayfinding display in real time or near real time, with desirable specificity of targeting is very challenging because of a number of factors such as variability of user factors, challenges in estimating user intent, range of products/services that may be available in a complex physical environment, lack of integration with external data sources that may enable better targeting of users, and so on. As a result, using prior art solutions, targeted messaging of users of a wayfinding display was only possible using highly customized solutions that as a result were not economically feasible. Also, product/service offerings and factors affecting targeting of users change quickly over time and therefore updates of programming and workflows for enabling targeted messaging are required and this adds further to cost.

There is a need for a technology platform that addresses these requirements.

In addition, given that physical locations vary in terms of the number of wayfinding displays required, operator requirements regarding data hosting and data security, and/or the external systems that wayfinding systems need to connect to in order to enable targeted messaging that meets operator business objectives, an innovative computer network architecture is needed for implementing a wayfinding technology platform, as none is available in the prior art, nor is such an architecture obvious to a person skilled in the art. This computer network architecture is required to ensure that the wayfinding technology platform that meets these requirements is scalable, which is also important for ensuring financial viability.

The wayfinding technology platform described also requires a system and method for generating wayfinding content (usually including map information) that includes or is associated with other messaging content in a way that is consumable by the particular user, given his/her objectives. The prior art does not disclose a mechanism for tailoring the display of targeted messaging in this way.

It is an object of one aspect of the present invention to obviate or mitigate one or more of the aforementioned disadvantages associated with the prior art, and/or to achieve one or more of the aforementioned needs and/or objects of the invention.

### SUMMARY

In this respect, before explaining at least one embodiment in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In one aspect, a computer network implemented system is provided for generating and displaying interactive map information, wherein the system includes: (a) one or more computing devices, each including a display; and (b) a central server linked to the computing devices; the computing devices are linked, directly or indirectly, to the central server, and are configured to display wayfinding content and optionally associated content; characterized in that: the central server is linked to one or more remote systems for acquiring information or updates to information; and the central server includes or is linked to an integrated wayfinding content management utility that enables definition and updating (i) a wayfinding map for a particular location, the wayfinding map embodying relationships between a plurality of waypoints, and logic for interpreting and responding to one or more wayfinding requests made by one or more users by means of a computing device; (ii) one or more customer business objectives; and (iii) one or more rules for (A) optionally establishing dynamically a user profile based on one or more wayfinding requests from a user and optionally further based on or more attributes of the user captured from the user or accessed from a user profile accessible to the central server, for (B) generating one or more targeted messages for promoting the business objectives, the targeted messages being based on one or more business rules and optionally based on the user profile, and for (C) optionally determining one or more display parameters for displaying the wayfinding content, and the targeted messages in connection with the wayfinding content, in a way that promotes the business objectives; the central server includes or is linked to a targeted message generating utility that is operable, based on the rules, to dynamically create one or more targeted messages that may include information from the one or more remote systems, and integrate the targeted messages into the wayfinding content (“integrated wayfinding content”), and initiate the display of integrated wayfinding content that promotes the business objectives.

In another aspect, the central server is operable to analyze the user profile so as to determine one or more parameters of probable user interest (“user interest attributes”) for the location, and to generate and initiate the display of the integrated wayfinding content based on the user interest attributes.

In yet another aspect, the business rules are defined or selected by an administrative user using one or more administrative user interfaces presented by the content management utility, wherein the business rules may be based on one or more marketing strategies established by the customer.

In a still other aspect, the business rules are based on a schedule established for selection of targeted message content from a library accessible to the central server, the library including targeted message content for use in generation and display of integrated wayfinding content.

In another aspect, two or more computer devices are linked to a local server, and each local server is linked to the central server.

In yet another aspect, the central server includes an application repository including one or more server applications for providing the functions of the content management utility.

In another aspect, each computer device is to obtain the wayfinding requests from a user, and optionally one or more information elements identifying (“identification data”), and wherein the computer device includes a messaging utility for assembling a message including the wayfinding requests and optionally the identification data, and for transferring the message to the central server, and in response the central server sends a reply message including one or more parameters and information files for assembling the integrated wayfinding content and displaying the integrated wayfinding content to the user.

In a still other aspect, the system is operable to update the user profile iteratively based on further wayfinding requests or interaction of the user with targeted messaging, and to updated the integrated wayfinding content based on updates to the user profile.

### DESCRIPTION OF THE DRAWINGS

In the drawings, various embodiments of the present systems and methods are illustrated by way of example. It is to be expressly understood that the description and drawings are only for the purpose of illustration.

FIG. 1 is a system diagram illustrated one aspect of the system of the present invention.

FIG. 2 is a further system diagram illustrating another implementation of the system of the present invention.

FIGS. 3a and 3b illustrate a possible implementation of the computing device element of the present invention, in this case implemented as a kiosk.

FIGS. 4a and 4b show abstractions of possible arrangement of functions in an user interface presented by operation of the present invention.

FIGS. 5a to 5k illustrate possible implementations of the invention by showing possible integrated wayfinding displays presented by operation of the present invention.

FIG. 6 illustrates a representative workflow enabled by the system of the present invention.

In the drawings, various embodiments of the present systems and methods are illustrated by way of example. It is to be expressly understood that the description and drawings are only for the purpose of illustration.

### DETAILED DESCRIPTION

In one aspect, a computer network implemented system is provided for generating and displaying wayfinding information that integrates targeted messaging (“integrated wayfinding content”), wherein the system includes: one or more computing devices (10), each including a display; and a central server (12) linked to the computing devices for enabling the generation and display of the integrated wayfinding content. Significantly, the integrated wayfinding content enables the generation and delivery of multi-channel, multi-media wayfinding information and thereby provides a new, innovative advertising platform and method. The computing devices (10) may be referred to as “clients” in this disclosure.

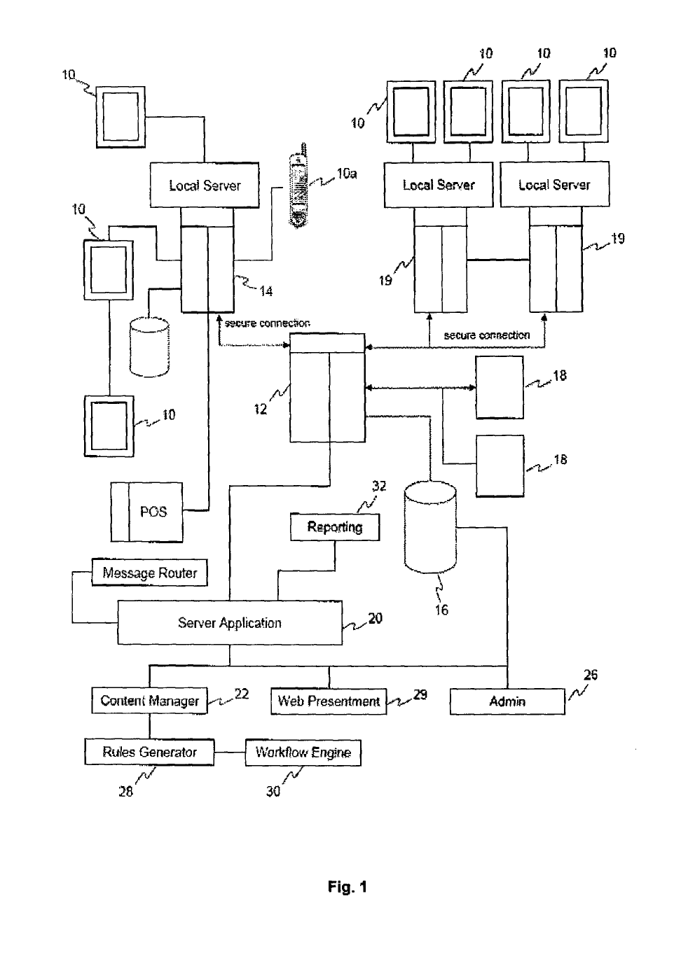

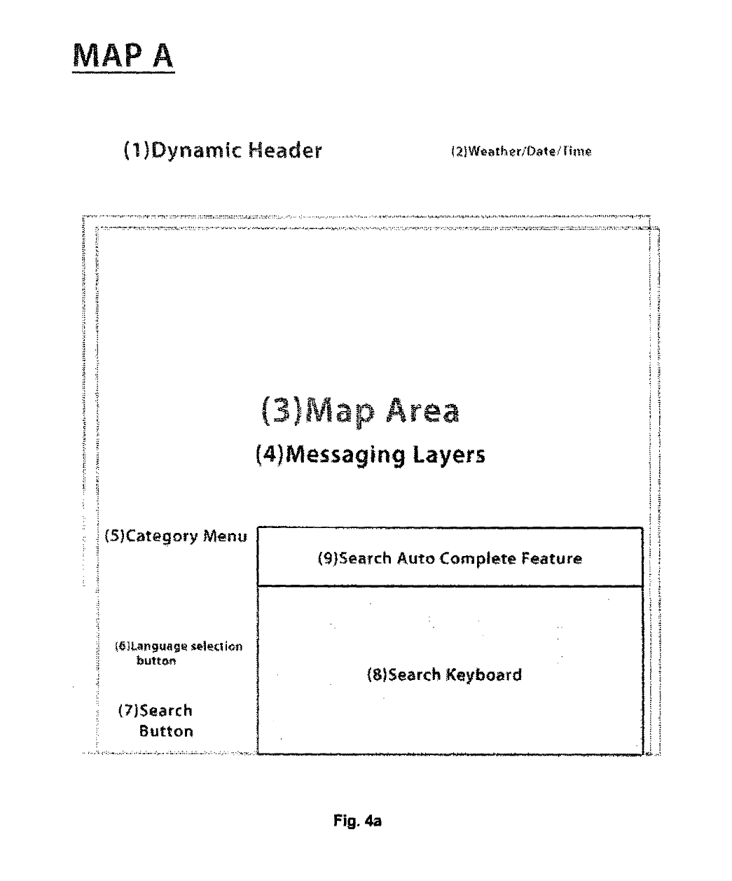

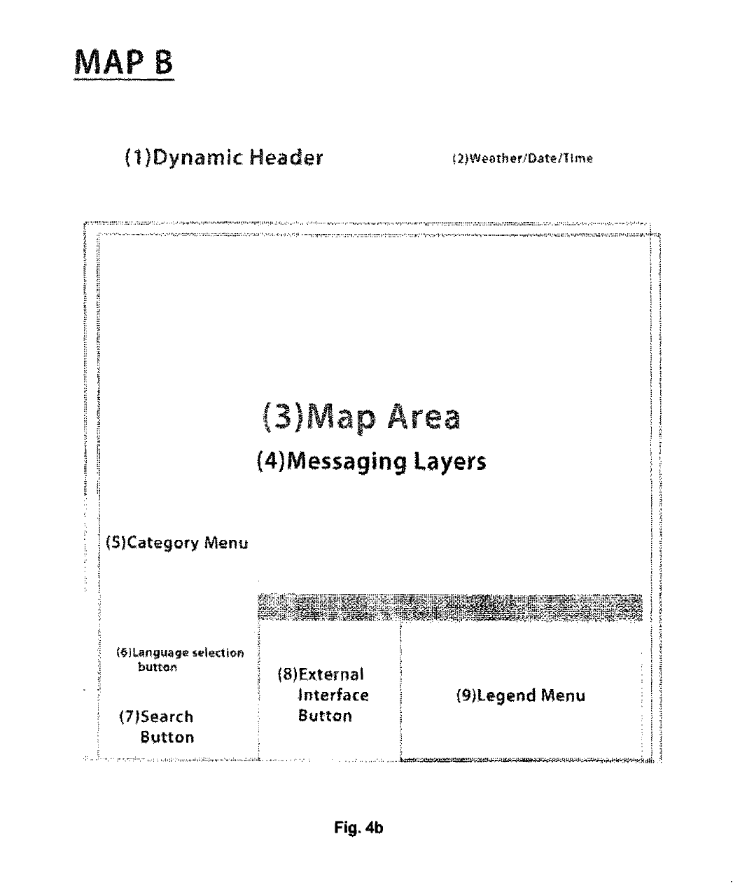

As best shown in FIG. 1, each computing device (10) is typically connected to a local server (14), and the local server (14) connects to the central server (12). The computing device (10) generally includes a display that is suitable for consumption of the rich media content referred to in this disclosure. For this reason, the computing device (10) generally includes a suitable screen display (16) as shown in FIG. 4a, which may be a standard high resolution screen. The computing device (10) generally also includes a computer such as a microcomputer and a storage medium (not shown). In certain implementations, it may be desirable to have a significant number of computer devices (10) and therefore in one aspect of the invention, the hardware/software resources required at the computer device (10) are relatively minor, thereby reducing the cost of producing each computer device (10).

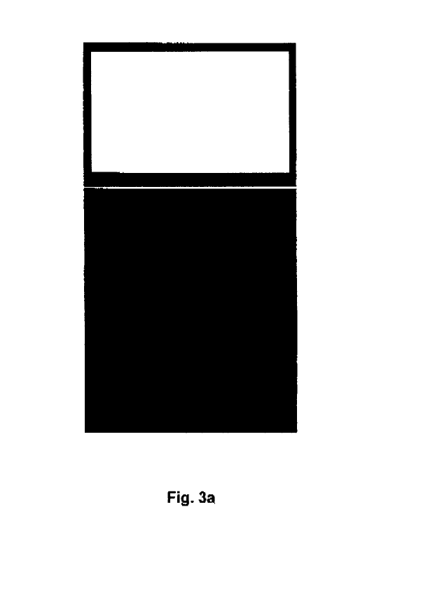

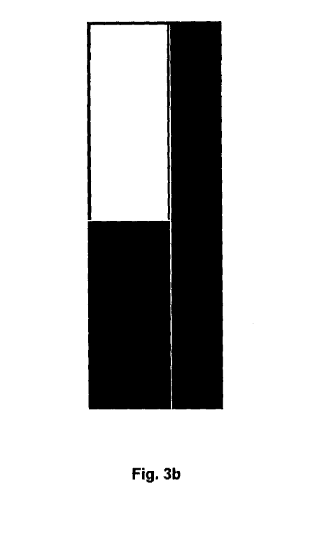

The computing device (10) includes one or more features or mechanisms to enable a user to interact with integrated wayfinding content, including by means of touch, tap, gesture, or input to a keyboard interface. The computing device (10) may be implemented as a kiosk, as shown in FIG. 3a, but also may be implemented as a wall mounted screen display or any other suitable hardware/software implementation. If implemented as kiosk the computing device of the present invention may run a property (e.g., mall) map and/or interface, and process all interactions with the system users. The user interface may preferably be implemented in association with Flash™ software. The Flash™ program may preferably communicate with the property (e.g., mall) server to access to maps, stores, advertisements and/or messaging. Preferably, apart from any end consumers, there may be at least three different types of users according to the present invention: (1) agents—i.e., users allowed to create and/or update messages and/or advertisements; (2) controllers—i.e., users responsible for checking entered information and/or propagation of information to property subsystems; and (3) administrators—i.e., users allowed to register new properties, and/or to define property structures and/or maps.

It should be understood that the system of the present invention may be implemented so as to integrate with mobile devices of a user. In other words, targeted messaging, or aspects of targeted messaging, as described, may be delivered to a mobile device of a user such as a smart phone, also user input may be obtained using his/her smart phone, an application residing on his/her smart phone, or by the smart phone accessing one or more web services by means of mobile browsing functionality. The present invention therefore contemplates integration mobile devices in various aspects of integrated wayfinding content generation and delivery. The computing device (10) may be said to include optionally a mobile device, as shown in FIG. 1 (10a).

The computing device (10), in one implementation of the invention, is connected to a local server (14). The local server (14) may be any manner of computer system, having hardware/software/networking/storage medium resources for connecting with the computer devices (10) and with the central server (12) to enable the functions and features described. It should be understood that a computing device (10), provided that it has the necessary hardware/software/networking/storage medium resources, may be configured to operate as a local server (14) to one or more computing devices (10). As further explained below, and as illustrated in FIG. 1, one aspect of the invention is a scalable and flexible computer network architecture for generating and displaying integrated wayfinding content that incorporates the central computer (12), linked to multiple local computers (14), who in turn link to one or more computing devices (10).

The central computer (12) is linked to a database (16) that supports multi-tenant data structures in that a central server (12) may enable the provision of services to multiple customers.

The central server may be implemented using a distributed server architecture or a cloud computing network. The various information elements may be hosted on local systems of a customer for example, linked to the central server (12) by means of the local server (14). Alternatively cloud based data hosting options may be used, in which case a cloud based data hosting service may be linked to the central server (12). As a further alternative, the local server (14) may be linked to a database (18) that includes information elements such as the library including targeted message content. The local server (14) may provide an interface to connect computer devices to one another and to facilitate secure data communications with the central server.

The central server (12) may be linked to one or more remote systems for obtaining information (whether based on a push or pull architecture) from one or more databases associated with a remote system (18), for delivery of information as part of targeted messaging, and optionally also for dynamic configuration of business rules based on the information from third party systems. Information may be accessed from remote systems (18) using one or more web services and/or data communications. Alternatively, common data stores may be defined, accessible by remote systems (18) and the central server (12).

In one implementation of the invention, local servers (14) may include an administrative computer program (not shown) that (a) receives input from administrative users (through a local computer or remotely through a web interface supported by the administrative computer program) to modify the rules (explained below), and (b) may provide access to one or more reports based on user metrics. The local server (14) tracks data from clients, and consolidates communications between multiple clients (10) and the central server (14). One or more local servers (14) may be used at a single location. Multiple local servers (14) may be linked to cover multiple locations associated with a single customer. The local server (14) may interface with one or more clients (10) to extract/process/respond based on user activity, and provide clients digital assets (such as for example advertisements, promotions or mechanisms enabling users to access promotions such as tokens, certificates or QR codes.

The platform of the present invention may be linked to or integrate with campaign managers used for example for Internet marketing campaigns. The present invention may present one or more user interface, implemented as a dashboard that enables subscribers to the system to design, deploy and manage campaigns that include the use of integrated wayfinding content.

As shown in FIG. 1, the computing devices (10) are linked to the central server (12) via the local servers (14). It should be understood, however, that the present invention also contemplates linking the computing devices (10) to the central server (12) directly. The computing devices (10) are configured to display wayfinding content and optionally associated content as described, in order to provide access to users to the integrated wayfinding content as described.

The central server (12) is linked to one or more remote systems (18) for acquiring information or updates to information. The remote systems (18) may be any manner of remote system for accessing a variety of data sources for consumption by the present system such as for example:
mobile data sources and/or media (e.g., mobile applications, SMS text, mobile telephone technologies);
advanced advertising data sources and/or media (e.g., augmented reality advertising tools, rich media digital file formats, REID technologies);
communications tools and/or media (e.g., software applications enabling voice and video communication via the kiosk);
website sources and/or media (e.g., sharing data and information between the system and a website);
QR code sources and/or media (e.g., barcodes that, when scanned with a web-enabled mobile phone, send information to the user);
facial recognition technologies (e.g., presenting a message based on the physical profile of a user); and/or
security technologies (e.g., the system may implement tools that track users)

In one implementation of the invention, as shown in FIG. 1, the central server (12) incorporates or is linked to a server application (20) which may be implemented, for example, as an application repository. The server application (20) includes an integrated wayfinding content management utility (22) (or “content management utility”) that enables the generation of integrated wayfinding content as described herein. The content management utility may be implemented as a web application, that provides access to a series of functions and features by means of a web browser, presented by operation of a series of web screens presented using a suitable web presentment utility (24). The content management utility (22) may be implemented using screens and features similar to a content management system or CMS, adapted to incorporate the features particularized herein.

In one aspect of the invention, the content management utility (22) includes an administrative utility (26) that may be a standard administrative layer for managing access to the various platform features, including for example hierarchical access to platform features and associated information, on a customer by customer and user by user basis, for example to ensure that customer information is only available to authorized customer personnel, and also to ensure that only authorized managers have permissions to deploy or make changes to campaigns incorporating targeted messaging enabled by the platform of the present invention. The administrative utility (26) may incorporate security features for managing access to specified resources, provided in a manner that is known and utilizing existing technologies and best practices.

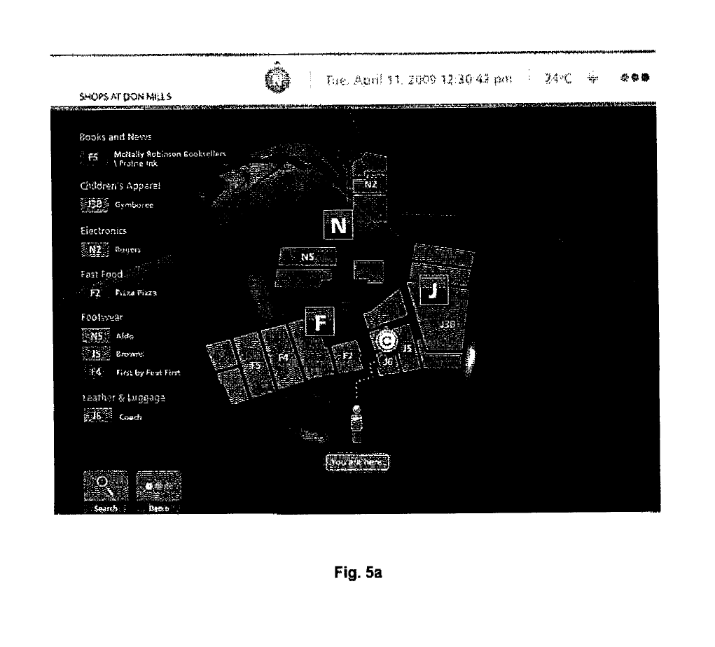

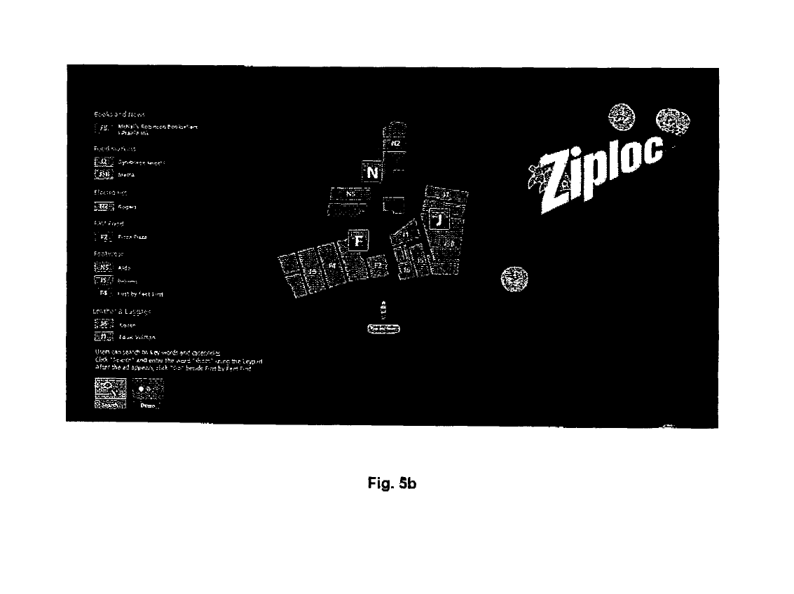

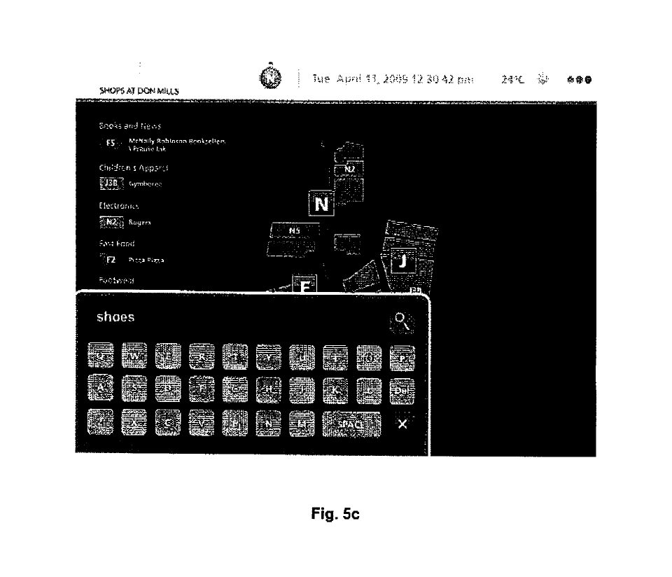

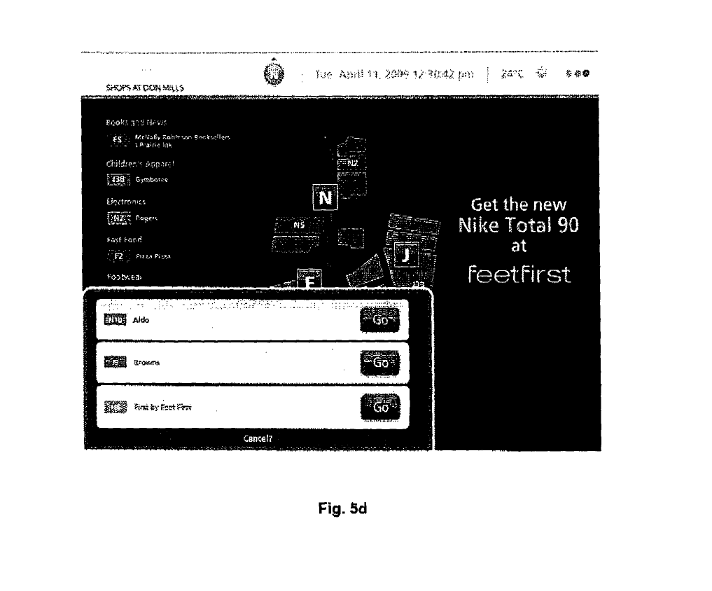

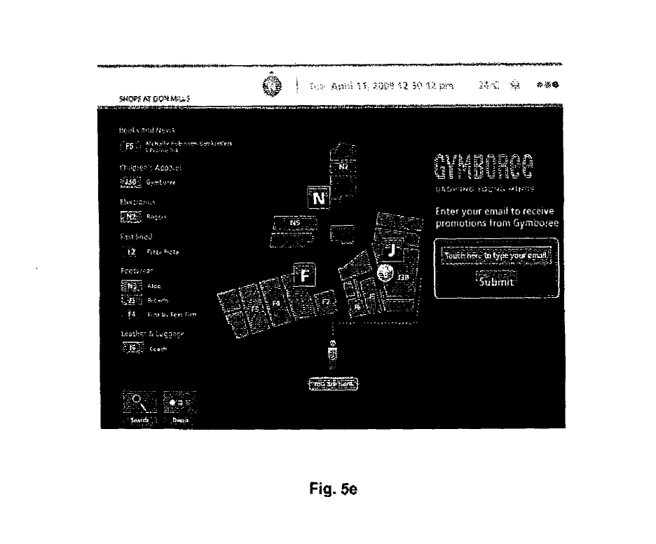

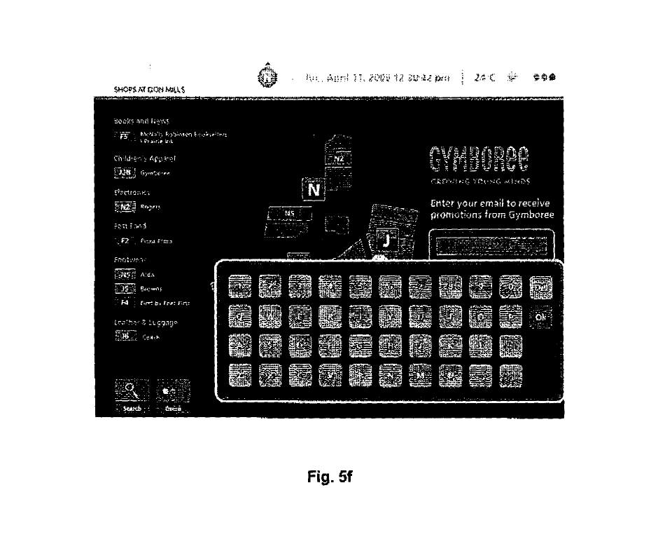

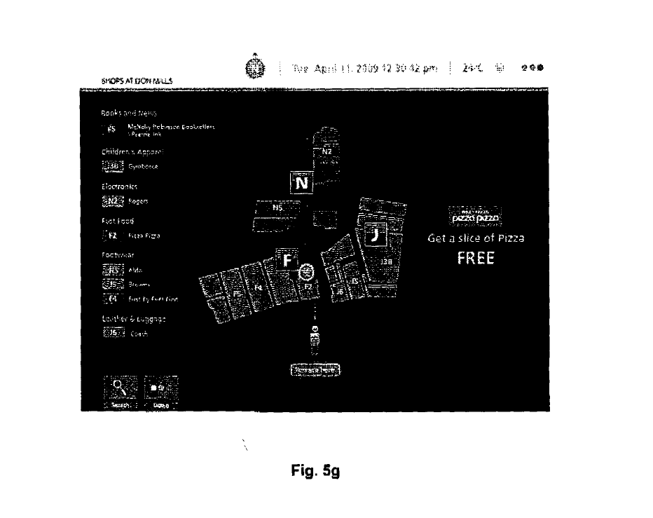

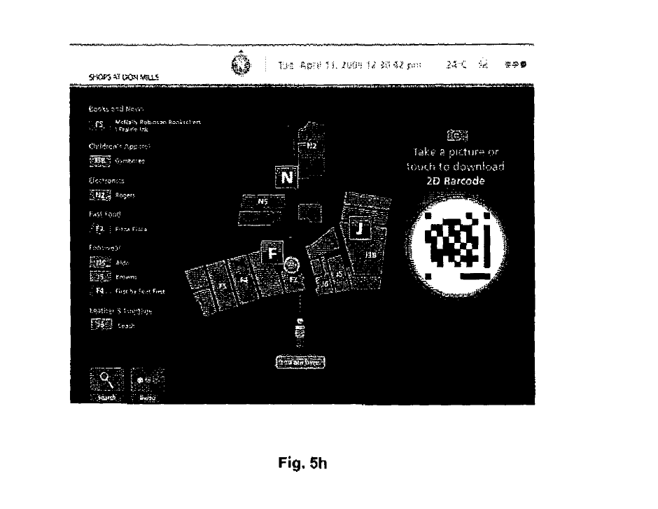

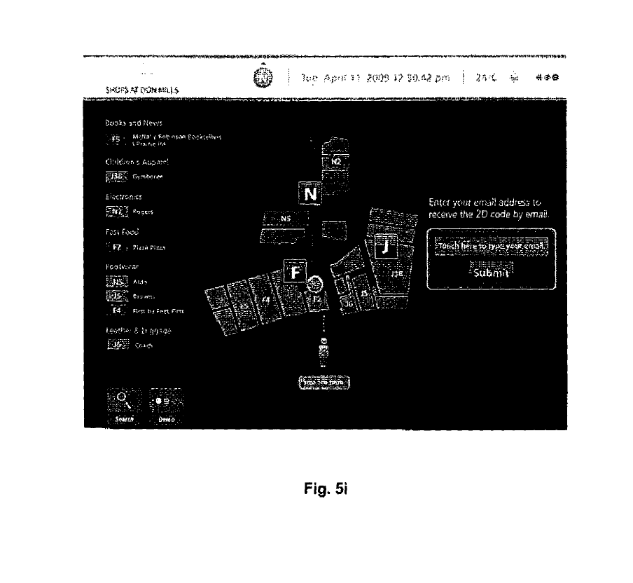

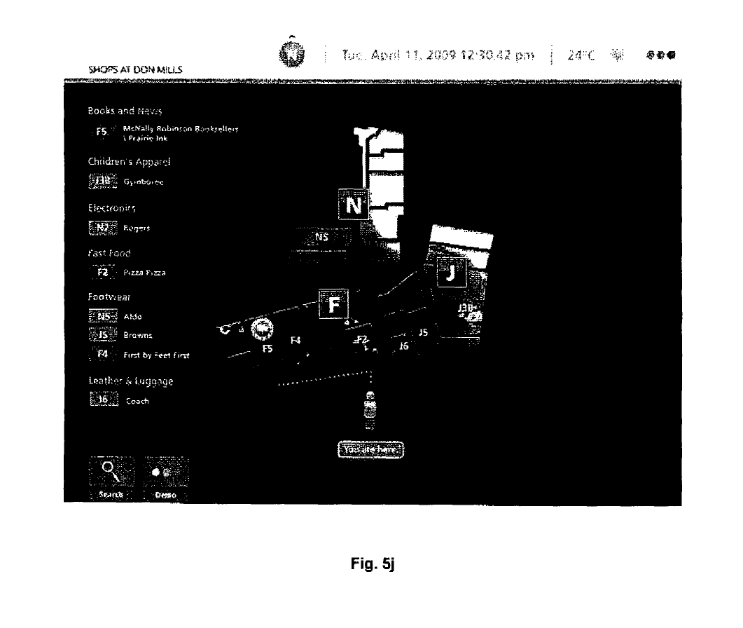

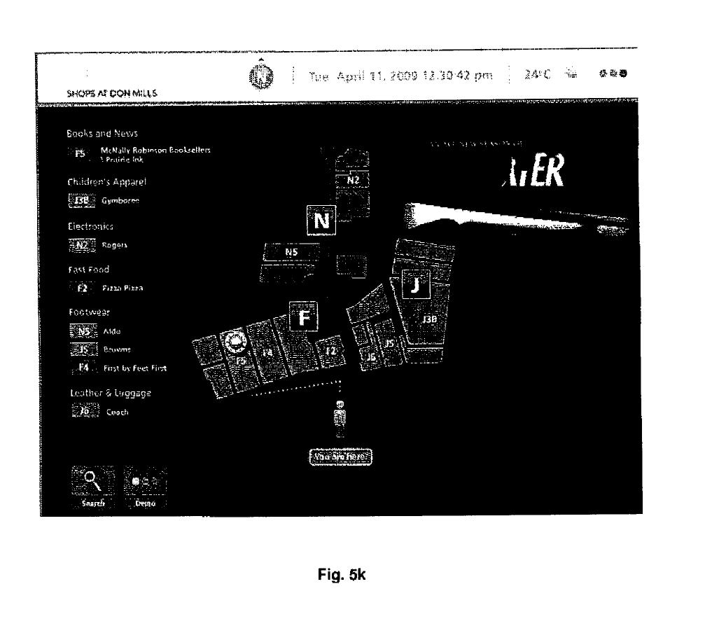

The content management utility (22) enables authorized users to configure a wayfinding map for a particular location, the wayfinding map embodying relationships between a plurality of waypoints, and logic for interpreting and responding to one or more wayfinding requests made by one or more users by means of a computing device (10). The server application (20) may include or link to a map creator (now shown) that enables an administrative user to upload and/or configure a map that may be used to generate one or more maps for display on the computing devices (10) and also to define the location based logic that is used by the rules generator (28) that is further explained below. FIGS. 5a to 5k shows representative embodiments of integrated wayfinding content incorporating maps based map content created using related functions of the content management utility (22). In another aspect of the invention, the content management utility (22) includes one or more features for defining, capturing, or acquiring one or more customer business objectives. The system of the present invention supports both general and specific business objectives. These may include increasing sales generally, increasing sales of specific products, reducing inventory of specific products, or running a specific digital marketing campaign. The features related to customer business objectives may be integrated with a marketing campaign dashboard that may enable authorized users to design, deploy and/or manage campaigns that include the use of integrated wayfinding content of the present invention. Also, the platform of the present invention may be linked to or integrated with campaign managers used for example for Internet marketing campaigns.

The content management utility (22) includes a rules generator (28) that enables the definition of the rules that may be used for the purpose of generating and delivering the integrated wayfinding content of the present invention. The rules generator (28) may be implemented for example using a variety of screens or menus and may include functionality similar to those used in rules builders for other purposes in other systems. A variety of different rules are supported by the platform of the present invention. These include rules for establishing dynamically a user profile based on one or more wayfinding requests from a user. These wayfinding requests are based on user interactions between the user and a client device (10), which in one implementation may be logged and processed by the associated local server (14). According to the rules, the user profile one or more attributes of the user either captured from the user or accessed from profile accessible to the central server (12). Examples of such attributes may include demographic information, past purchasing behaviour, that may be accessed based on provision of identification information by the user such as a loyalty number, or credentials automatically obtained from the user based for example on an automated basis by accessing one or more functions of mobile device 10a associated with the user, co-operating with local server (14). For example, the system may incorporate various authentication technologies or techniques. The computing devices (10) may also include for example a biometric identification system for identify the user using for example one or more biometric attributes of the user.

The rules generated by the rules generator (28) may determine the parameters for generating one or more targeted messages for promoting the business objectives. These aspects of the rules are best understood as business rules, and example of these are provided in the use cases below.

Another aspect of the rules defined using the rules generator (28) relate to display parameters for displaying the integrated wayfinding content, incorporating for exampled targeted messages, in a way that promotes the business objectives. Depending on a number of circumstances, the optimal way in which to display targeted messaging in connection with the wayfinding information may vary. For example, it may be desirable to present a display object on the display in proximity to the destination requested by the user. Depending on other information displayed, it may be desirable to increase or decrease the size of the display object. The overall objective may be to present targeted messaging in a way likely to appeal to the user but without distracting from the user's ability to obtain the wayfinding information or other related information that s/he desired. The rules may include various parameters for displaying information, and these rules may be based for example on applicable marketing best practices.

The system of the present invention also includes a targeted message generating utility (not shown) that is operable, based on the rules, to dynamically create one or more targeted messages that may include information from the one or more remote systems, and integrate the targeted messages into the wayfinding content to form the integrated wayfinding content of the present invention, and initiate the display of integrated wayfinding content by the computing devices (10) in a manner that promotes the business objectives. The generation of messages may be achieved in a number of ways including by generation of content by the central server (12), and transfer of this content to the computing devices (10) via the associated local server(s) (14). Alternatively, the central server (12) may assemble a message that incorporates certain data elements to be included in integrated wayfinding content (such as an attachment including digital advertising content) and instructions for parameters for generating and displaying the integrated wayfinding content based on such data elements and also on one or more data elements available at the local server (14), including via systems linked to the local server (14) and associated with a customer such as their point of sale system, inventory management system, or other relevant system.

In one aspect of the invention, the system is operable to present messaging that is relevant to a path determined based on the wayfinding requests of the user. The system of the present invention is operable to enable geo-targeted and contextual messaging.

It should be understood that the features of the targeted message generating utility may be distributed as between the central server (12) and the local server (14), and optionally as between other system linked to either resources, in order to respond for example to customer requirements and customer system requirements.

The server application (20), for example the content manager utility (22) may incorporate one or more functions for analyzing the user profile so as to determine one or more parameters of probable user interest (“user interest attributes”) for the location, and to generate and initiate the display of the integrated wayfinding content based on the user interest attributes. User interest attributes may provide insight into particular products/services or associated promotions that are likely to be of interest to a user. For example, based on past purchase behaviour, current weather information obtained from a remote system (18) (there may be snow in the forecast), and user input indicating that the user wishes to go to seasonal area of a store, the system may determine that the user is likely to be interested in one of 3 likely products (shovel, anti-freeze, or walkway ice). Based on inventory level and past brand preferences, the platform may deliver advertisements, offers or promotions related to these products, optionally pointing to a location in the map that corresponds to the location of the applicable products in an aisle of a store. The size, colour and other attributes of advertisements, offers or promotions may be adjusted to present an overall appealing visual impression to the user that does not interfere with the conveyance of the desired wayfinding information. Advertisements, offers, or promotions may also be displayed as transparent display objects that still permit the viewing of the map information. Or for users that have interacted with margin promotions with regularity exceeding established thresholds, information may be displayed outside of the map information. This example is meant to illustrate the scope of possible rules that may be defined using the rules generator (18), and implemented using the workflow engine (30) to dynamically adjust integrated wayfinding information to user interest attributes that enable more specific targeting of the user in real time or near real time.

In one aspect of the invention, user interactions or accessing of user related profiles or attributes act as triggers to the system, based on which the content manager (22) determines the rules from the rules generator (28) that are applicable based on the user interactions or other user profile aspects, for example by operation of a) mapping function. The system therefore filters the associated rules based on the current user profile. The applicable rules, as determined by the system, then trigger one or more workflows based on the filtered rules by operation of the workflow engine (30). Various parameters for generating the integrated wayfinding information (including for example acquisition or adaptation of external information from external systems), and display of the integrated wayfinding information, are embodied in workflows established by the workflow engine (30). The workflow engine (30) may also establish the functions exercised for example by the central server (12) and/or the local server (14) and/or resources of the computing device (10) in enabling the system processes described herein. For example, as explained above, depending on the system configuration, data used to assemble integrated wayfinding content may be obtained from a data centre of a customer linked to local server (14) or a linked customer database (not shown), or database (16). A message router linked to or part of the server application (20) assembles the required content for transfer to the local server (14).

It should be understood that the process of determining parameters for generation and delivery of integrated wayfinding information may be iterative. The user may interact with the integrated wayfinding information by engaging sequentially in a plurality of user interactions or providing further information that may be used for example to better determine user interest attributes, and this may trigger additional rules which may result in modification of the integrated wayfinding information.

The system of the present invention also includes a reporting utility which may be implemented as reporting utility (32) that is part of server application (20). The reporting utility (32) may include for example an analytics engine for analyzing activities logged to the system such as user interactions including acceptance for example of offers for example to analyze such information so as to generate return-on-investment metrics and other metrics. The reporting utility (32) may then generate reports based on such analytics. Further details regarding reporting are provided below.

Local servers (14) may include an administrative computer program that (a) receives input from administrative users (through a local computer or remotely through a web interface supported by the administrative computer program) to modify the rules, and (b) may provide access to one or more reports based on user metrics. The local server tracks data from clients, and consolidates communications between multiple clients and the central server. One or more local servers may be used at a single location. Multiple local servers may be linked to cover multiple locations associated with a single customer. The local server may interface with one or more clients to extract/process/respond based on user activity, and provide clients digital assets (such as for example advertisements, promotions or mechanisms enabling users to access promotions such as tokens, certificates or QR codes.

Communications between clients and local servers may be initiated using XML messages over HTTP/S. Communications between local servers and the central server may occur by means of SMTP communications.

The client implements a presentation layer for the system solution. The presentation layer is operable to render maps, waypoints, paths, and advertisements, based on user input and business rules. In one implementation, the presentation layer may run for example in a cross platform Adobe AIR runtime environment. Clients may use XML structured data for storage and application interfaces/services for delivering integrated wayfinding content as described.

Communications between clients and one or more associated local servers may be implemented using XML messages over HTTP/S. These messages may follow a request/response format whereby a request from a client may trigger file transfers and other queued data seemingly unrelated to the initial request based on request data collected from a user by the client, including based on associated time data, user actions or business rules. Linked to the local server, and supported by the local server and/or the central server depending on the distribution of operations defined by the rules, and their implementation, information from remote systems may be made available at the clients based on access of web services, RSS, and so on.

Clients may interface with local external devices or system using a suitable network connection for example NFC (Near Field Communications), Blue Tooth, or HTTP. Examples of local external systems or devices include for example a point of sale system or inventory management system associated with the location where the client is deployed. The information obtained from the external system, and integrated into the integrated wayfinding content may include inventory levels or promotions based on inventory levels and other factors. The clients may also interface with an external device associated with a user, such as a mobile device of a user. Specific examples are provided in the use cases.

The present invention, in one aspect, provides a digital interactive wayfinding system with embedded user-based advertising, messaging and/or real-time information that enables stakeholders (e.g., venue operators and advertisers) to target messages and/or advertisements to users (e.g., consumers) based on users' wayfinding selections and/or other real-time data variables. For example, stakeholders such as venue operators and advertisers may decide to select messaging spots based on one or more perceived demographics of users and/or consumers who are interested in specific selections and/or locations on the wayfinding map. In addition to the users' specific selections and locations of interest in conjunction with the wayfinding system, and real-time data related to such selections and locations, will determine the message and/or advertisement presented by the system.

Email and/or other contact data may preferably be collected directly from a kiosk in a wayfinding area. Personalized emails (from various stakeholders, such as venue operators and advertisers) may preferably be delivered from the database. In addition, in certain channels, users may be able to have specific information delivered to their mobile phones with wayfinding instructions for certain products.

Certain aspects of the general structure and various components of the invention may be better appreciated and/or understood following a consideration of the attached figures, diagrams, photographs, sketches and/or flowcharts.

In one aspect of the invention, the computing devices (10) may be implemented as computer kiosks that display marketing, informational and/or other messages, with advanced animations that correspond to user selections and sometimes real-time data that is integrated into the wayfinding information to provide dynamic, interactive content including map information and targeted messaging.

Preferably, using the customized ticketing system, advertisers and/or property managers may have the ability to choose where their messages and/or advertisements will appear through customized interfaces provided by operation of the present invention. Preferably, in addition, advertisers and/or property managers may be afforded an ability to store multiple advertisements in a database for use in any given campaign period.

An interactive display device in accordance with the present invention may be implemented to provide a “smart directory”. The interactive display device may provide an interactive experience to engaged user with high impact messaging.

The kiosks according to the present invention may preferably allow numerous different formats (and/or categories of formats) of messages and/or advertisements for presentation to users—some of which are described herein. Actual messages and/or advertisements can also be customized in many ways to suit the needs of each individual client (be it a property manager, retailer, advertiser, content provider, or another interested party).

### Further System Implementation

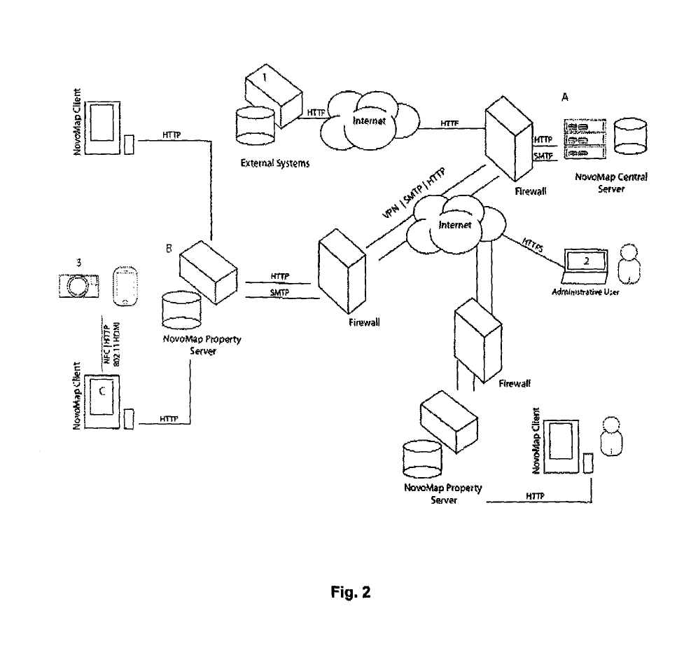

FIG. 2 provides an additional view of the system implementation of the present invention, in a particular embodiment thereof.

In FIG. 2, the central server is referred to as the “NovoMap Central Server” (A). The NovoMap Central Server may be implemented as a centrally hosted, role based, project/object workflow platform that defines the wayfinding structure, content rules, and business processes for one or more instances of the NovoMap wayfinding user interface. The Central Server core function is to define, and manage the relationships between waypoints, messages, and schedules. Using a browser based application interface, authorized users can add waypoints, keywords, messaging, and business rules, The NovoMap Central Server applications may rely on the use of a Java application server, a JBDC compliant database, and an email server. The NovoMap Property Server provides interface to connected NovoMap clients and facilitates secure data transport to the NovoMap Central server.

From a communications perspective, the NovoMap Central Server interfaces with the following:
External Systems (1) for the exchange of data to be displayed on NovoMap Clients, and or in constructing business rules. Relationships with external systems can be defined through the administrative interface, or through scripting. The exchange of information with external system is achieved through the use of pre defined web services, and or mail messages;
Administrative Users (2) for the definition and management of projects. Administrators use a web browser to access role specific functions of the central server, via an HTTP connection; and
NovoMap Property Servers to transfer updates to the program logic, defined by input from administrative users and external users, and to receive tracking information as an input to reports. NovoMap Property Servers are associated with a NovoMap Central Server by way of an authentication key, as assigned by the system administrator. The exchange of information between the NovoMap Central Server and associated NovoMap Property Servers is via SMTP.

In one implementation, there is no direct communications between the NovoMap Clients, and the NovoMap Central Server.

In FIG. 2, the local server is shown as a “NovoMap Property Server” (B). The NovoMap Property Server brokers tracking data from NovoMap clients, consolidating the data and communications between the NovoMap Central server and NovoMap Clients. One or more property servers may exist for a project, and in the cases of larger deployments, multiple property servers may exist for a single venue. NovoMap Property Server applications may also use a Java application server, a JBDC compliant database, and an email client. The NovoMap Property Server provides interface to connected NovoMap Clients and facilitates secure data transport to the NovoMap Central server

From a communications perspective, NovoMap Property Servers interfaces with the following:
NovoMap Clients, to extract/process/respond based on user activity, and provide NovoMap Clients with assets/data defined through administrative users and external systems. Initiated by NovoMap clients, communications between the clients and property server is generally through XML messages over HTTP/S;
NovoMap Central Server to transfer consolidated tracking data, and receive updates to the application. These updates can include data, rules/scripts, schedules, and creative assets. The exchange of information between the NovoMap Central Server and associated NovoMap Property Servers is via SMTP; and
External Systems (1) to exchange data in fulfilling business rules. Relationships with external systems can be defined through the administrative interface, or through scripting. The exchange of information with external system is achieved through the use of pre defined web services, or common data stores.

Lastly, the computing devices are shown in FIG. 2 as “NovoMap Client” (C). The NovoMap Client represents the presentation layer of the NovoMap solution. Its core functionality is the rendering of maps, waypoints, paths, and advertisements, based on user input and business rules.

The rich media NovoMap Client runs in the cross platform Adobe AIR runtime environment, and Human Interface Devices compatible with the host Operating System. NovoMap uses XML structured data for storage and application interfaces/services.

From a communications perspective, NovoMap Clients interface with the following:
NovoMap Property Server(s), Initiated by the NovoMap Client, communications between the clients and property server leverage XML messages over HTTP/S. These messages follow a request/response format whereby a request from a NovoMap Client may trigger file transfers and other queued data seemingly unrelated to the initial request. A NovoMap Client may request data from a NovoMap Property Server based on a timer, user action, or business rule
External Systems (1), to display location specific data, as part of a centrally defined business rule or presentation template. Relationships with external systems can be defined through the administrative interface, supported by scripting. The NovoMap Client receives information from these systems through web services, RSS, etc.
External Devices (3), NovoMap Clients may interface with devices not directly connected to the hardware enclosure. Using relationships defined by centrally business rules, data interfaces between External Devices and the NovoMap Client can include NFC (Near Field Communications), Blue Tooth, and HTTP

An External System may be any data source used by the NovoMap Central Server, Property Server, or Client, for the purpose of displaying information on the NovoMap Client Interface, or in constructing a business rule for processing by one or more NovoMap Clients. For example, an external system hosts product data for a retail location that has a NovoMap installation. A relationship would be defined between the NovoMap Central Server and the external system, whereby the Central Server would read the information and populate the appropriate data tables for use by the NovoMap Client. Alternatively, an external system hosts advertising content for brand x. A relationship would be defined between the NovoMap Central Server and the external system, whereby the systems would synchronize available advertisements for display based on any defined schedule or business rule

An Administrative User is any person with a valid user account for accessing the administrative interfaces hosted by the NovoMap Central Server. Administrative User is a general term that can refer to any number of pre defined system roles. Example a) An administrator responsible for managing tenants at a shopping mall. Example b) An advertising agency responsible for developing Ad content for display on one or more NovoTouch Clients.

An External Device is any device, not directly attached to a host hardware structure that exchanges data with a NovoMap Client. Example a): a mobile phone. Example b): an audience measurement device.

### Display of Integrated Wayfinding Content

FIGS. 4a and 4b illustrate a representative map structure for displaying integrated wayfinding information in accordance with the present invention. FIG. 4a shows “Map A”, which includes a number of different possible interface areas. Area (1) may be a Dynamic Header that displays an image that is called from a Real Time Data Control System that may be used as part of the system of the present invention. Area (2) may relate to Weather/Date/Time and displays real time CPU and web data of current weather, date and time. Area (3) may provide a map area displaying the map itself, features and associated plug-ins for example a 2D or 3D map, Store/code names, Legend icons, MapTouch feature—displays a bubble with store/code name when map is touched or QR code with store information and map image delivered to the users mobile. Area (4) may relate to messaging layers, which may be implemented as messaging layers that are transparent place holders that display the system responses for example an Advertisement QR code interface or Email interface or Survey interface or Flyer Interface. Area (5) may relate to a category menu. The category menu displays each type of store (place like a mall) or item (place like Canadian Tire) i.e.: food, clothing, cafes, electronics. Each category brings up a list of corresponding stores or items. Area (6) may provide a Language Selector Button that enables users to select different languages, once chosen the interface labels are displayed in a selected language. Area (7) may provide a search button that depending on implementation may consist of list for selecting between keywords such as airport gate numbers. Area (8) may define a search keyboard. Rather than choosing stores/items from a list, users can search for keywords like: food, burger, coke, hungry etc. Area (9) may be associated with a Search Auto Complete Feature where word suggestions pop up based on letters typed by the user.

Map B illustrates an alternative interface arrangement, including in Area (8) an External Interface Button. Once selected an interface pops up: for example a Video conferencing screen, a Survey, a Flyer, or a social media “share”. Area (9) may be associated with a “Legend Menu” which may consist of an icon based menu that highlights the following on the map: phones, washrooms, parking, service desk etc.

FIGS. 5a to 5k illustrate representative interactive screens displayed by operation of the present invention, with various forms of targeted messaging integrated into the wayfinding content.

The present invention may also provide a range of user interface functions including:

When the map directory is not in use, messages and/or advertisements may be launched as a screensaver loop. In some preferred embodiments according to the present invention, to activate the map directory, users may simply touch the screen to begin. Preferably, the message and/or advertisement may fade out (to the map directory) when a user touches the screen.

When activated, a loop of messages and/or advertisements may preferably be presented from the entire LCD (or other display) screen of the kiosk.

Full-screen background messages and/or advertisements may be dynamically displayed when a user selects (and/or otherwise indicates an interest in) a store from the map directory. Messages and/or advertisements may preferably be linked with store selections based on target demographics.

When activated, the map and directory may preferably continue to be presented while the message and/or advertisement run in the background, substantially across the entire screen. According to some preferred embodiments of the invention, only one message and/or advertisement may be displayed per user selection, messages and/or advertisements can be static and/or animated.

Messages and/or advertisements may preferably be displayed beside the map—e.g., when the user is searching by keywords, categories and/or specific stores.

When activated, a message and/or advertisement may preferably appear anywhere in the available space without disrupting the map or directory. Preferably, only one message and/or advertisement will be displayed per user selection. Messages and/or advertisements may be static or animated.

Side messages and/or advertisements may, for example, be presented according to the invention in response to a search query. The devices, systems and/or methods may involve one or more of the following steps in presenting a side message and/or advertisement.

In a first step, a user may preferably type in a search string. For example, a user may visit a shopping mall to buy shoes, and may enter the keyword “shoes” into a kiosk provided according to the present invention.

In a second step, according to the present invention, a number of search results may be returned in response to the entered search string. And, a side message and/or advertisement may be presented to the user.

The present invention may enable a user to interact with a brand (e.g., by scanning QR codes, entering an email address, playing games, etc). Interactive advertisements may preferably be provided in the form of static and/or animated advertisements. According to some preferred embodiments, simple Flash™ games may preferably be embedded for a high level of user engagement. Interactivity may preferably be designed not to engage users for more than about 30 seconds. Preferably, users may be afforded an ability to enter an email address and/or to receive immediate offers on a mobile device (e.g., a web enabled mobile device). For example, users may preferably be able to scan 2D bar codes and, upon downloading a related mobile software application, instantly receive offers, information and the like. More information concerning 2D bar codes is provided elsewhere herein. Preferably, the interactive advertisement may fade out if a user makes a new selection,

### Example of the Method of the Present Invention

Various aspects of the method of the present invention may be explained by means of representative computer implemented workflows enabled by the present invention. The invention is not limited to particular combinations of steps meant to explain examples of such workflows.

The method of the present invention may involve a combination of steps for presenting an interactive advertisement. (1) logging of one or more user requests and optionally accessing one or more user attributes, so as to compiled a current user profile. (2) Transferring the user profile to a central server, the central server in response accessing a set of relevant rules and based on the current user profile establishing a set of rules for generating and displaying wayfinding content that optionally integrates targeted messaging depending on the applicable rules. (3) Initiating a workflow based on the applicable rules so as to generate and display to the user wayfinding content that integrates targeted messaging based on the current user profile, if required by the applicable rules. (4) Logging interactions between the user and the targeted messaging.

In another aspect of the method of the present invention:

(1) a user interfaces with the client application of the present invention by way of touch, gesture, accessibility device, or alternatively through mobile applications or mobile web services, and optionally through various loyalty interfaces, e.g. NFC, RFID, SMS, etc.

(2) the user interactions with the system are recorded by type e.g. touch and by the function accessed within the client application. This information is packaged/transferred to the messaging queue for centralized reporting, and separately, processed by the content manager, and specifically the rules engine.

(3) queries resulting from user interactions with the client application, e.g. search for gate A23 at an airport, are processed by the rules engine. When processing queries, the following may be evaluated against available messages:
Time of Day
External Data feeds
Destination Metadata (Category, Keywords, Location)
User Path

A Rule can be
a) A simple match e.g. any interaction on this day receives promotion 1,
b) Compounding e.g. its Valentine's Day, 5 PM, and the guest is searching for “flowers”,
c) Path based e.g. snack shop beside a children's play area, and/or
d) Any combination of available metadata.

Once a rule and message are matched, the resulting message ID's are forwarded to a messaging router for scheduling and playback queuing. The messaging router or messaging interface validates the cached content version information with the associated local server. When out of sync, an update is downloaded. Once validated, the messaging interface creates a play list, serving one or more messages to the client application.

(4) In addition to contextual messages delivered by the messaging interface, a Data API consumes third party data for display using predetermined rules, such as showing the weather in a container in the top right corner of the screen.

A further workflow for implementing the present invention with a customer organization may be described as follows:
A proposal is presented to customer based on scope of work and technology requirements.
On approval, a project kick off meeting is held to define the user interface design, data requirements (flight schedules, POS inventory, etc), business rules (profiles and semantic layers that allow parameters to be attached.
Client assets are collected:
   Data (Waypoints, tenant lists, product inventory)
   Raw map files
   Creative assets
A digital map is created that is optimized to work within the system and also to conform to size/orientation requirements. Data points are connected to particular points in the map, in one implementation of the invention.
The digital map is imported into a waypoint path editor:
   Each waypoint has an identifier that corresponds with the content management utility or Real Time Data Control System. The identifier allows data to be delivered to each waypoint.
System ‘path finder’ automatically calculates shortest distance from each unique ‘You are Here’ starting position.
   System allows administrators to block areas that cannot have wayfinding routes (i.e. in a hospital, creating black out areas where public access is restricted. The path will automatically generate a path around this areas)
The system content is imported (waypoints, categories, amenities, products, lists of keywords). System automatically generates an XML file that connects all system data with each unique map waypoint identifier
A profile template is created for the customer:
   Profiles are comprised of a set of parameters that includes a list of waypoints (i.e. products) that have data/content (i.e. advertisements) associated to them based on data variables (i.e. weather temperatures)
   For example, a particular retailer may want to display advertisement for products based on the weather temperature.
      The system's ‘rules Wizard’ is invoked to allow the customer to correlate events (temperature reaches −10 C) with messages (advertisement for ‘snow blowers’) or system features (surveys, QR codes, email interface)
Optionally one or more loyalty systems is linked to the system:
   An associated loyalty program may be an opt-in program that the customer can join in order to receive rewards/incentives in exchange for providing personal preferences:
      Customer registers through online interface that automatically shares data with the system
      Customer receives unique member number that is entered on system interface
   The Rules engine wizard allows client to associate messages to system user loyalty preferences:
      For example, if the loyalty user has indicated that they want to know about specials on Product A
         Client (Airport Authority) can show messages to the loyalty user that promote the store(s) that sell Product A in the airport.
         a Airport Authority has the ability to self the media space to any airport tenants that wish to promote products that are aligned with loyalty member preferences
         Rules can be applied to any waypoint or data feed that is part of the system
System is populated with messages/advertisements in database by client.
System schedule of displaying messages and rules engine is populated by client
System automatically matches the user interface buttons (interactive points for users to navigate system) to the tracking and reporting system:
   System produces tracking results for all user interactions and posts them to the online reporting tool
Administrator defines the language sets available for system user interface (i.e. English, French, Mandarin, etc.):
   Administrator applies language dictionary to system with appropriate languages
   Language dictionary can automatically translate all system text labels and content:
      Identifier is set for each waypoint or data entry that indicates language required
   Administrator can manually change the automated translations through RTDCS.

### Reporting System

Preferably, the reporting system may enable advertisers and/or property managers to access information in real-time—e.g., pertaining to the number of users, advertisements played, advertisements completed and/or not completed (i.e., advertisements that are called to the screen and are either played in entirety or stopped prematurely due to a new selection by users), number of contacts collected (email addresses), time and date of interactions, group reporting by date, region, etc. The reporting system may also preferably enable the quick editing of information substantially in real-time.

Preferably, according to the invention, all kiosk usage and/or activity may be tracked and reported. Total reporting and/or tracking may preferably be available substantially in “real time”. Reports may preferably be generated on the number of times each individual message and/or advertisement was displayed. Preferably, the system enables customization of dates and/or times for any desired reporting period. Reports may preferably enable discernment of messages and/or advertisements displayed by store, category, and/or keyword searches.

Reports may preferably provide the number of email addresses collected. Reports may preferably list and/or measure the emails collected by message and/or advertisement and/or by category. The reports may preferably also identify whether a message was completely and/or incompletely presented (e.g., by the duration of time which the message appeared). The devices, systems and/or methods according to the present invention preferably enable advertisements to be adjusted mid-campaign, if necessary. According to the invention, the devices, systems and/or methods may preferably provide stakeholders (e.g., venue operators and advertisers) with comprehensive tracking and reporting on a weekly and/or monthly basis, or as required. Reports may preferably be customized upon request.

### Additional Implementation Detail

The content manager of the present invention may be understood as a utility that defines project data fields and their components. The database may store all system content and data. The reporting system receives and displays system usage activity. The workflow engine contains project processes and associated scheduling. The workflow engine may include or be linked to a plurality of workflow plugins, which may be implemented as customized processes, specifically configured to achieve functionality of a specific project (for example a script that retrieves an online flyer from the pubic website of a particular retailer, compiles the flyer in a format that is optimized for the system and then schedules the flyer to be displayed on the User Interface at the appropriate time). The content manager may also include or linked to a User Interface Engine that embodies controls for the front-end user interface. The content manager may also include or be linked to User Interface Plugins, which are additional plugins that extend the user experience by enabling incorporation in the wayfinding content of QR codes, email and surveys.

The message router mentioned above in a particular implementation controls all SMTP messages in the system back and forth from the central server to the various local servers (containing advertisements, waypoint data, tracking information).

The content manager may be implemented using a known RTDCS or Real Time Data Control System. The RTDCS is used to set up each specific project and defines the data components and how data is linked to the User Interface and User Interface Plugins.

Project content (waypoints, buttons, maps, etc.) is saved to the database and is assigned associated with system content (i.e. the result that appears when a button category is selected on the User Interface—user selects ‘Cafes’ and a list of coffee shop locations are displayed for the user to select from). These system ‘responses’ that are associated to map locations need to be propagated and saved in the system database in order to be active. User Interface Plugins are mapped to the appropriate User Interface locations (i.e. QR code appears with offer for Free Coffee when Tim Horton's is selected by users on client PC).

System data and content is delivered from the central server to the applicable local servers using the Message Router over SMTP. User activity on the client are stored and sent back to the Reporting System using the Message Router.

Integrated wayfinding content in according to the present invention may be implemented using for example any Rich Media interactive presentation, built using tools such as Flash, HTML 5.0,

The map creator facilitates the ready creation of visual representations of the venue where the wayfinding software is deployed (e.g., airports, other mass transit hubs and systems, malls, big-box retail stores, other store structures, warehouses, hospitals, universities, other campuses, tourism centers and/or other high traffic locations), and/or the ready uploading of messaging content and/or advertising content from third parties (e.g., advertising agencies, property managers, retailers) via an online web interface.

### Advantages

Various advantages of the present invention are described above, and also would be obvious to a skilled reader. Some of these advantages include the following:

The present invention may in one aspect provide an interactive wayfinding system where the messaging is directly connected to the user interface.

As an extension of its features, the present invention may enable better data capture. Stakeholders (e.g., venue operators and advertisers) are afforded a means to contact the people who use the digital interactive wayfinding system and/or to receive data from them. For example, users may enter an email address and feedback e.g. survey or request for information (RFI), which may be delivered by the system electronically to a corresponding advertiser. The system may collect real time, detailed usage data for each interaction with the digital wayfinding system. The system may collect user behaviour and personal information for further use, such as, for example, in store-to-user targeting outside of the point of sale. The present invention may enable the collection of consumer data and deliver personalized emails to users (e.g., consumers) substantially in real-time.

The present invention may provide a user-friendly interface, which provides information on demand and an easy way to navigate wayfinding areas (e.g., shopping centers). Examples of other locations include airports, other mass transit hubs and systems, malls, big-box retail stores, other store structures, warehouses, hospitals, universities, other campuses, tourism centres and/or other high traffic locations

Users may preferably receive special offers and/or incentives via their mobile devices.

With the use of digital map directories in accordance with the present invention, high-traffic locations may preferably eliminate and/or substantially reduce any costs previously associated with re-printing maps when changes occur (e.g., when property tenants move in or out). Property managers may preferably directly control content displayed on the interactive directory.

Preferably, the interactive directory associated with the present invention may provide a long-term revenue stream through advertising fees, added value to potential and/or existing retailers, and/or a medium for property managers to promote special events.

The present invention may also preferably present other useful dynamic information to users of the digital wayfinding system (e.g., weather, subway and bus schedules).

The wayfinding system integrates with other commercially available technologies and/or “plug-ins”, such as mobile technologies (e.g., QR Codes, Mobile Augmented Reality, Device Specific Applications, SMS,), advanced advertising tools (e.g., Augmented Reality advertising tools, NFC, RFID location technologies), real-time data sources (e.g., schedules, advertising bids, waypoint status), various communications software applications (e.g., Video conferencing, virtual worlds), data sharing (e.g., XML, database, or web service based interfaces), and facial recognition technologies (e.g., presenting a message based on the physical profile of a user).

The present invention enables the display of wayfinding information in a highly unique and innovative format. The wayfinding interface is a layered presentation, where the map remains the focal point throughout the experience. Advertisements, messages, video conferencing, etc., are integrated in the presentation vs. placed in specific windows as similar systems would present.

The present invention enables the creation of unique and innovative map information that integrates wayfinding and targeted messaging. The map information and optionally the associated targeted messaging can be dynamically assembled from a variety of external sources based on business rules and also based on real time variable such as for example date/time of day information, weather information, information related to the status of the physical environment (such as transit updates, road closures, facility closures and so on).

The present invention provides examples of specific computer network architectures and system implementations that enables the deployment of the integrated wayfinding content platform in a way that associated information on which user targeting may depend can be updated easily, and even automatically based on external data. For example, updates to product/service information via inventory management systems can result in an automated updates to logic embodied in the rules referred to above.

The devices, systems and/or methods according to the present invention may preferably, but need not necessarily, facilitate the ready, and/or the ready uploading to a main application of messaging content and/or advertising content from third parties (e.g., advertising agencies, property managers, retailers) via an online web interface.

Targeted messages by operation of the present invention are delivered to a captive audience. The interactive display device may enable the collection of valuable consumer data for follow-up communications (by email and/or in association with OR codes). The present invention may be implemented so as to provide tracking and/or reporting tools, preferably in-depth analysis of campaign metrics.

### Use Cases

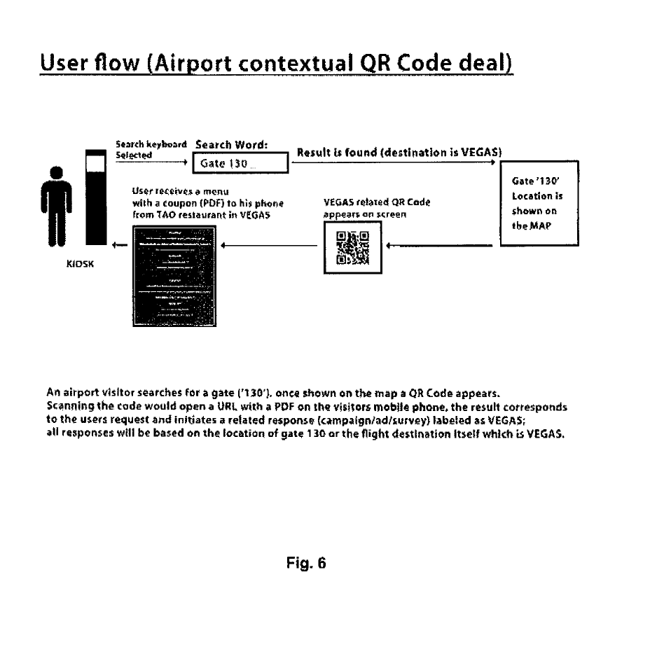

In an airport, for example, a system according to the present invention may locate and/or display gates for travelers, calculate walk times, display flight status and/or display the current average time to go through security screening. Depending on the search by the user, the system may automatically identify that the user is going to a certain location and/or destination and then present a message based thereon (e.g., the user might enter Gate C21, and the system may recognize that such user is destined for Las Vegas and present a coupon for a hotel located in Las Vegas). Such offers may be presented via On screen messaging, SMS, Social Media, or other supported plug ins. A route to a gate searched by the user, and the system may recognize that the user is likely to traverse a certain path and/or pass by a particular vendor or other attraction (e.g., a coffee shop). Depending on the time of day and/or other factors, as well as the associated business rules, the system may present a message relevant to that path and/or attraction. For example, the system may present a message regarding coffee in the morning, and one regarding one or more sandwiches in the afternoon. This feature of the system may provide a geo-targeted and/or contextual messaging. The system employs multiple business rules engines, creating opportunities for the system or its authorized users to respond to either specific, or trending, user requests. FIG. 6 illustrates this use case.

The wayfinding user interface of the present invention can be programmed to respond to multiple business rule types, based on individual or compounding factors, including:

### Time of day e.g. 8:00 PM

Search category e.g. Sundries
Search destination e.g. Las Vegas
Keyword(s) e.g. Neck Pillow
Time to departure: 2 H
Walk time: 7 Minutes

Another use case relates to implementation of the invention by a mass transit agency.

Mass transit agencies are striving to improve the experience of passengers, improve operational efficiencies and generate new sources of revenue. The present invention may help transit agencies improve the passenger experience and operational efficiencies.

The system of the present invention may be implemented as a comprehensive solution offering interactive signage delivered through public information stations (kiosks). The system converges multiple technologies into an intuitive interface that allows users to view and engage with complex and large data sets in formats without being overwhelmed. One aspect of the user experience enabled by the present invention is the delivery of real-time data that can be displayed in the users native language and based on their preferences and selections while engaged with the system. The system allows users to connect to operators in real-time through two-way third party video conferencing equipment. This and other platform features, bring new efficiencies and revenue sources that for venue owners were previously not possible.

In prior inventions, interactive systems have typically required complex integrations of individual components from multiple, systems and vendors, resulting in high total cost of ownership and limited scalability.

The present invention solves these problems through the core system architecture being designed to integrate third party systems and data (i.e. Cisco Tandberg, bus schedule data, weather feeds, etc). The present invention provides a system architecture that enables interactive wayfinding that combines third party technologies into one platform while allowing a ‘rules engine’ to determine what is displayed to users based on pre-determined parameters. The rules engine is managed by the client and allows them to associate messages/advertisements through the Real Time Data Control System (RTDCS).

As a real life example, could be contracted by a regional transit provider to integrate an interactive interface (GUI) for the system navigation (i.e. touch-screen kiosk) with a series of third party data feeds that deliver real-time data to the system (transit schedules, restaurant/shopping ads). Furthermore, the system is operable to display messages to system users (passengers) based on parameters predefined in the system by the transit client. For example, the system user may be searching for a bus time schedule for a destination (“Toronto”). The system cross references the database for messages related to the “Toronto” profile. Automatically the system asks the user to enter a system loyalty card number. If the user has a loyalty card number, the system will reference the user's profile data and make recommendations for shopping and restaurants in Toronto that match the user's preferences (previously entered by user on loyalty website or recorded history from previous sessions).

Prior to the user interaction, a systems administrator has populated messages/advertisements for each system profile (Toronto/Restaurants, Shopping, etc) using the Real Time Data Control System. The RTDCS has a rules wizard tool that enabled the administrator to apply the messages/advertisements to the “Toronto” profile.

If the user does not have a loyalty card number, the system could display a QR code or another message that gives the user instructions on how to join the loyalty program. The system could also display random advertisements that are associated with each profile (Toronto), not necessarily based on the users specific preferences.

In addition to the contextual messaging functions of the system, the system allows the transit agency to integrate third party technologies (e.g. Cisco “Tandberg” video conferencing platform). This integration allows users to receive real-time connectivity to an operator (virtual concierge). The system also allows the user to select the language that they interact with the system interface (GUI) and select the language they speak to the virtual concierge operator.

The transit agency realizes numerous benefits:
Improved visitor/customer experience:
   Reduced anxiety of customer by providing accurate schedules and wayfinding information on demand (in their language)
   Customer is engaged and excited by ‘rich media’ experience
   Customer is engaged and excited by contextual information delivered (coupon served to customer based on their location)
Improved operational efficiency through virtual agents, interactive employee training, and increased security
Increased revenue opportunities by providing a new digital advertising footprint and enabling more context-sensitive advertising, and the delivery of digital coupons and promotions.
Improved safety & security through emergency messaging capabilities, as well as providing a platform that can scale to support live video surveillance and two-way video communications with virtual agents and emergency responders.

It should be understood that various extensions to the invention are possible without departing from what would be readily apparent to a person skilled in the art reviewing the details of the present invention. For example, the system may be configured to interoperate with a variety of different data sources, and adapting the invention and the rules/workflows that it enables to incorporate such data sources. For example the system may integrate with various social media platforms to pull and push information in connection with the product/service related campaigns incorporating the resent invention. The disclosure refers to various system components and software utilities, however, it should be understood that the present invention is not limited to any particular system, network, or software architecture.

1. A computer network implemented system is provided for generating and displaying interactive map information, wherein the system includes:
(a) one or more computing devices, each including a display; and
(b) a central server linked to the computing devices;
the computing devices are linked, directly or indirectly, to the central server, and are configured to display wayfinding content and optionally associated content;
characterized in that:
the central server is linked to one or more remote systems for acquiring information or updates to information; and
the central server includes or is linked to an integrated wayfinding content management utility that enables definition and updating of:
(i) a wayfinding map for a particular location, the wayfinding map embodying relationships between a plurality of waypoints, and logic for interpreting and responding to one or more wayfinding requests made by one or more users by means of a computing device;
(ii) one or more customer business objectives; and
(iii) one or more rules for (A) optionally establishing dynamically a user profile based on one or more wayfinding requests from a user and optionally further based on or more attributes of the user captured from the user or accessed from a user profile accessible to the central server, for (B) generating one or more targeted messages for promoting the business objectives, the targeted messages being based on one or more business rules and optionally based on the user profile, and for (C) optionally determining one or more display parameters for displaying the wayfinding content, and the targeted messages in connection with the wayfinding content, in a way that promotes the business objectives;
the central server includes or is linked to a targeted message generating utility that is operable, based on the rules, to dynamically create one or more targeted messages that may include information from the one or more remote systems, and integrate the targeted messages into the wayfinding content (“integrated wayfinding content”), and initiate the display of integrated wayfinding content that promotes the business objectives.

2. The system of claim 1, wherein the central server is operable to analyze the user profile so as to determine one or more parameters of probable user interest (“user interest attributes”) for the location, and to generate and initiate the display of the integrated wayfinding content based on the user interest attributes.

3. The system of claim 1, wherein the business rules are defined or selected by an administrative user using one or more administrative user interfaces presented by the content management utility, wherein the business rules may be based on one or more marketing strategies established by the customer.

4. The system of claim 3, wherein the business rules are based on a schedule established for selection of targeted message content from a library accessible to the central server, the library including targeted message content for use in generation and display of integrated wayfinding content.

5. The system of claim 1, wherein two or more computer devices are linked to a local server, and each local server is linked to the central server.

6. The system of claim 1, wherein the central server includes an application repository including one or more server applications for providing the functions of the content management utility.

7. The system of claim 1, wherein each computer device is to obtain the wayfinding requests from a user, and optionally one or more information elements identifying (“identification data”), and wherein the computer device includes a messaging utility for assembling a message including the wayfinding requests and optionally the identification data, and for transferring the message to the central server, and in response the central server sends a reply message including one or more parameters and information files for assembling the integrated wayfinding content and displaying the integrated wayfinding content to the user.

8. The system of claim 1, wherein the system is operable to updated the user profile iteratively based on further wayfinding requests or interaction of the user with targeted messaging, and to updated the integrated wayfinding content based on updates to the user profile.
